(19) United States
(12) Patent Application Publication
(10) Pub. No.: US 2018/0025116 A1
(43) Pub. Date: Jan. 25, 2018

(54) Clinical Event Management and Communication System

(71) Applicant: Arizona Board of Regents on behalf of University of Arizona, Tucson, AZ (US)

(72) Inventors: Jane M. Carrington, Tucson, AZ (US); Mihai Surdeanu, Tucson, AZ (US); Peter A. Jansen, Tucson, AZ (US); Angus Forbes, Chicago, IL (US)

(21) Appl. No.: 15/656,632

(22) Filed: Jul. 21, 2017

Related U.S. Application Data
(60) Provisional application No. 62/365,834, filed on Jul. 22, 2016.

(51) Int. Cl. G06F 19/00; G06F 17/30

(52) U.S. Cl. CPC G06F 19/322; G06F 19/345; G06F 19/3406; G06F 19/3431; G06F 17/30554; G06F 17/30867; G06F 17/3056; G06T 11/206

(57) ABSTRACT

A clinical event management and communications system for use in augmenting the electronic health records (EHRs) of a healthcare facility, which uses interfaces to access the same, for enhancing nurse and other healthcare provider decision-making and communications of patient event and other information.

### CROSS REFERENCE TO RELATED APPLICATIONS

This application is related to and claims the benefit of the filing date of U.S. Provisional Application No. 62/365,834, entitled “Clinical Event Management and Communications System,” filed on Jul. 22, 2016, the disclosure and contents of which are incorporated by reference herein in their entirety.

### GOVERNMENT LICENSE RIGHTS

This work was made with government under Grant No. R01 EB020395, awarded by NIH. The government has certain rights in the invention.

### BACKGROUND OF THE INVENTION

### Field of Invention

The present invention relates generally to software and information technology systems, and the human-machine interfaces useful thereto.

More specifically, the present invention relates to software solutions in the healthcare field, and in particular the health information technology and healthcare informatics fields. The present invention relates to systems for improving the communication of health-related information, such as clinical data, health risks, health conditions, and actual or potential medical events, to healthcare professionals in order to improve patient outcomes.

The present invention further relates to software for augmenting user interfaces, such as those associated with electronic health records (EHRs), in order to improve the interface experience for medical professionals who use EHRs.

### Description of Related Art

According to government and other sources, preventable medical errors may account for as many as 98,000 hospital deaths each year, most of which may be attributed to faulty processes, systems, and hospital conditions that may lead to mistakes being made. The mandated use of EHRs in hospitals nationwide is one approach hospitals have taken to reduce those mistakes. Even so, it is recognized that current EHRs have not achieved their full potential in reducing mistakes, due to several implementation problems.

EHRs are digital versions of individual patient paper charts. They are used to improve or enhance the quality of patient care, patient safety, healthcare delivery efficiency, and healthcare coordination, as well as reduce communications errors and health disparities. EHRs comprise patient-centered electronic data that is generally updated in real-time. They make information available instantly and securely to authorized users, such as a patient's healthcare providers. While EHRs contain a patient's medical and treatment history, they can also be used to develop and present a broader view of a patient's care. Mandated by law, EHRs are widely used in the U.S. healthcare industry. They are implemented at hospitals, primary care facilities, and clinics.

Companies that provide EHR software solutions include MEDITECH, Cerner, McKesson, Epic Systems, Siemens, CPSI, and General Electric.

In a survey of healthcare information technology professionals working mainly in hospitals (Frost & Sullivan, 2014), problems identified with using existing EHRs include time-consuming data entry tasks and significant difficulties in finding and reviewing data and information in EHRs, both of which result in significant loss of productivity for clinician end-users as well as potential risks to patient safety. Indeed, it is estimate that 10-25 pages of EHR data are generated per patient per nurse shift. In a setting where there are 5-6 nurses working each shift, a nurse arriving for a later shift would have to read 50-300 pages of data at the start of his or her shift simply to know what has happened in the last 12 hours at that facility.

It has been recognized that existing EHR software lacks standardization across systems and organizations that implement them, as most of the software solutions involve different user interfaces and other customized features.

It has further been recognized that EHRs provide opportunities for nurses to integrate data analyses (analytics) into their practices, but the process of recording, retrieving, and analyzing EHR data presents communications difficulties, such as interpreting and drawing conclusions from vast amounts of data, especially when different organizations implemented different software solutions having different interfaces (including widely differing inputs and outputs).

Moreover, existing EHRs software solutions generally lack a natural language query interface. In fact, many EHRs software solutions use interfaces that require nurses to enter information in a specific way, utilizing specific forms and the like, without the flexibility of entering and processing natural language queries.

Existing EHRs often use fixed and inflexible user interfaces (graphical user interfaces), or interfaces that do not take into account the specific manner in which a nurse might access data and information in EHRs. For example, depending on the situation, it may be difficult for nurses to sift through large amounts of heterogeneous data available in EHRs to identify useful information.

In addition to EHRs as a source of patient-centered data, many hospitals rely on verbal shift change reports, which are the recorded spoken words of nurses, prepared at the time of a shift change, concerning one or more patients under those nurses' care. Shift change reports generally summarize data already in a patient's EHR, but may include supplemental patient information that may not have made its way into a particular EHR.

What is needed, therefore, is a clinical event management system for use by nurses and other healthcare practitioners, in which a hardware and software solution augments any one of the existing software solutions with interface tools that enhance communication of data and information from EHRs (and verbal shift change reports, as needed). Such as system would have an interface that allows nurses to write their observations using natural language, which can be interpreted and correlated and understood in relation to “hard data” such as patients' vital measurements contained in EHRs. The interface should function on both desktop or tablet computers, as well as smartphones and dedicated handheld devices. Moreover, the graphical user interface should ease the cognitive burden on nurse users, for example by automatically generating useful graphs to help anticipate, predict, address, assess, remediate, and/or prevent adverse patient events and related outcomes.

Others have sought to address some of these needs. For example, in US2005/0020886, a patient monitoring method using specific rule-based algorithms is identified, in which real-time physiologic data received from patents is input into algorithms and a response is outputted. The reference states that responses may include alarms, possible causes associated with abnormal conditions, and actions for addressing abnormal conditions. The rule-based algorithms may be adjusted by clinicians and subject matter experts as needed, and may include specific variables, such as those for heart rate and blood oxygen content, or multiple sets of rules each with their own variables, such as combinations of variables associated with cardiovascular disease events. Moreover, multiple rule-based algorithms, which may be downloaded from a website, may be applied simultaneously to output either a unique response or multiple responses. The reference further states that the output may be generated on a display or input to a person's medical file.

Unlike the present invention, however, the above and other references do not involve, among other features of the present invention, the combined use of natural language inputs to and queries of a patient's EHR by nursing staff using an augmented user interface, and simultaneous real-time event assessment based on machine-learning and artificial intelligence algorithms used to generate graphics for simplified, rapid, and effective communication of event information to nursing staff.

### SUMMARY AND OBJECTS OF THE INVENTION

Clinical events are subtle changes in patient condition that have high risk towards failure to rescue (i.e. patient code) and are manifested by fever, pain, bleeding, changes in respiratory status, changes in output, and level of consciousness. Clinical events may be thought of as findings that ostensibly are unsurprising or lack distinction; however, they may lead to a sentinel event and thus are precursors of death. That is, clinical events are subtle changes that if not taken seriously have potential to spiral to crisis and unexpected death.

The present clinical event management system uses an augmented EHR interface for use with EHR software to enhance nurse decision-making and communications of patient clinical events and other information. The invention is effective at preventing cognitive overload by giving nurses an automated visual representation (such as, for example, in the form of bar charts, line graphs, and other diagrams) of a patient's vital signs, while providing patient event identification and likely clinical outcomes information.

The invention provides a means for nurses to enter their observations into the EHRs via the interface using natural language, and the software will automatically couple nurse observations with the related vital signs using color codes and other visual cues. The invention provides a means for nurses to enter their summaries in a verbal shift change report, and the software will automatically convert the speech into text which can then be added to the EHRs.

The present invention may be used to improve nurse communication about individual patients.

The present invention may be used to improve healthcare efficiency by enhancing communication between medical professionals, and by improving data collection and analysis processes involved in EHRs systems.

The present invention may be used to help nurses and doctors quickly evaluate and understand patients' data through visualization tools and natural language processing capabilities.

The present invention provides an EHRs software interface allowing nurses to enter observations using natural language. Healthcare providers can search the EHRs data and information with natural language inputs. For example, the software may receives a natural language query such as “How many patients have X symptoms?” and can return a response via the software's interface, including providing suitable graphics via the generated graphical user interface as needed.

One aspect of the present invention is its ability to predict a patient's likelihood for experiencing certain clinical events using predictive algorithms, thereby improving healthcare efficiency.

Another aspect of the invention is its ability to streamline and improve the efficiency of nurses who use EHRs to document and predict patient outcomes. The interface of the present invention may help nurses know what they should be looking for, and which clinical outcomes are most likely to occur.

Another aspect of the invention is improving data support for hospitals. Certain legislation (e.g., The American Recovery and Reinvestment Act of 2009) incentivizes hospitals to demonstrate meaningful use of EHRs. By allowing personnel to enter information using natural language (something as simple as “patient has a fever”), nurses can focus more on providing care to patients instead of filling out EHRs using inflexible user interfaces.

The natural language algorithms of the present invention would also be useful in the automation of a wide variety of tasks. For example, the present invention may be adapted so doctors and nurses could run searches of EHRs using natural language commands, such as “Has the patient had a fever since they were admitted?” and “How many patients have shown symptoms consistent with Valley Fever infection this year?” The interface tools of the present invention are also useful in interfacing with non EHRs software used in other industries, including interfacing with electronic batch records (EBRs), which contain data and information concerning different drug batches. Natural language algorithms may be useful in fields like biomedical text mining, in which text mining is used to collate information about proteins or other biological entities. There is possible utility for the invention anywhere that human interaction with computers can be better facilitated by graphical representation of complex data.

The present invention may be implemented at a single facility, such as a single hospital, or across multiple related or unrelated facilities, such as a hospital and community private practice healthcare providers that access the same hospital EHRs of their patients.

With those and other objects, advantages, and features of the invention that may become hereinafter apparent, the nature of the invention may be more clearly understood by reference to the following detailed description of a preferred embodiment of the invention, the appended claims and to the several drawings attached hereto.

### BRIEF DESCRIPTION OF THE DRAWINGS

FIG. 1 is a schematic block diagram according to one aspect of the present invention;

FIG. 2 is a schematic diagram according to another aspect of the present invention;

FIG. 3 is a process flow diagram of some of the software functions of one aspect of the present invention;

FIG. 4 is a diagram illustrating an exemplary graphical user interface generated by the software of the present invention;

FIG. 5 is a diagram illustrating a portion of the exemplary graphical user interface of FIG. 4;

FIG. 6 is a diagram illustrating yet another exemplary graphical user interface generated by the software of the present invention;

FIG. 7 is a diagram illustrating an exemplary graphical user interface generated by the software of the present invention;

FIG. 8 is a diagram illustrating another exemplary graphical user interface generated by the software of the present invention after clicking on a portion of the graphical user interface of FIG. 7 or some other graphical user interface page;

FIG. 9 is a diagram illustrating another exemplary graphical user interface generated by the software of the present invention after clicking on a portion of the graphical user interface of FIG. 8 or some other graphical user interface page;

FIG. 10 is a diagram illustrating another exemplary graphical user interface generated by the software of the present invention after clicking on a portion of the graphical user interface of FIG. 9 or some other graphical user interface page; and

FIG. 11 is a diagram illustrating another exemplary graphical user interface generated by the software of the present invention after clicking on a portion of the graphical user interface of FIG. 10 or some other graphical user interface page.

### DETAILED DESCRIPTION OF THE PREFERRED EMBODIMENT

Several preferred embodiments of the invention are described for illustrative purposes, it being understood that the invention may be embodied in other forms not specifically described below and/or shown in the drawings.

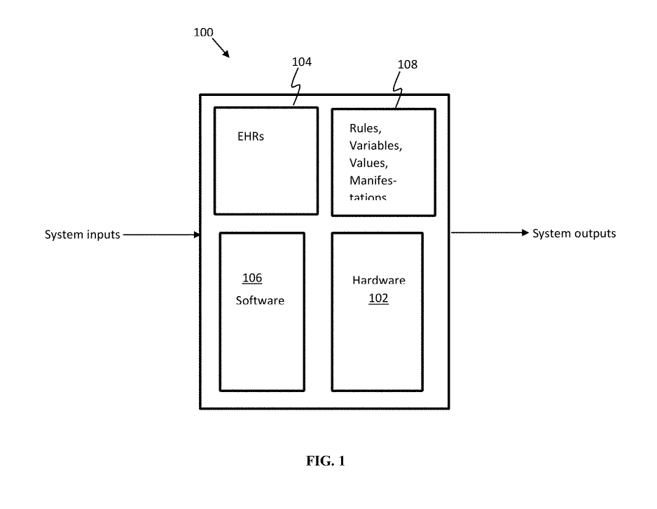

Turning first to FIG. 1, shown therein is a schematic block diagram of the clinical event management and communications system 100 according to one aspect of the present invention, showing the hardware 102, the EHRs 104, the software 106, and the various rules, variables, values, and manifestation descriptions, etc. 108 (collectively) used by the system, and the system inputs and outputs.

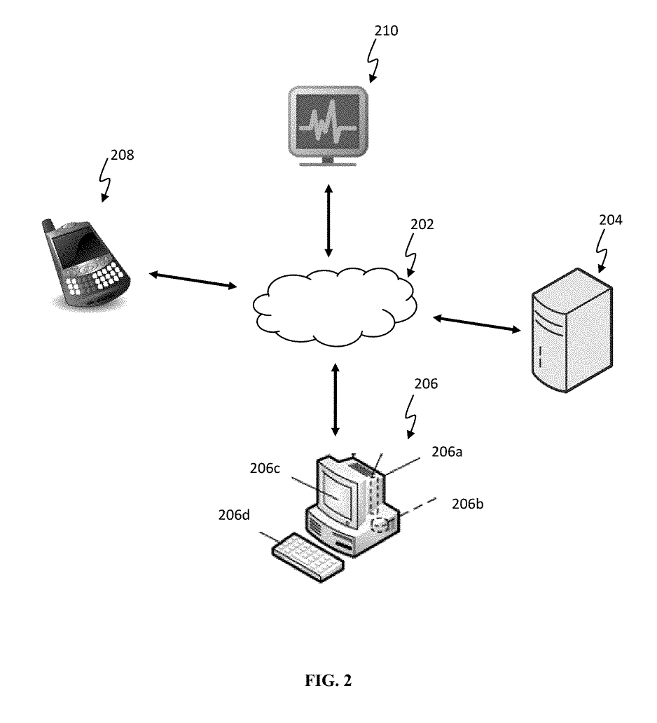

The hardware 102 features of the present invention include client computers, servers, storage devices, and network components, as better described with reference to FIG. 2.

The EHRs that may be useful in connection with the present invention are of the kind well known to persons of ordinary skill in the art, several of which have been previously described and identified.

The software 106 feature of the present invention, described in more detail below, include a software subsystem that interfaces with an existing EHR software application. Some of the software 106 inputs include, for example, user-entered natural language statements or notes, clinical data, lab results, device-generated data, observations, codes, criteria, patient data, insurance information, a taxonomy of words and/or phrases, indications of events, indications of risks, variables, values, and manifestations descriptions, among others.

Some of the software 106 outputs include, for example, patient-focused GUI charts, graphs, information, and reports; visual and audible alarms; event information; potential risks; and potential outcomes, among others.

The software 106 may include necessary authentication tools for authenticating users' access to the system 100. The software 106 may be downloadable from a remote server and installed on an existing computing system at a health care delivery facility. The software 106 may be installed as a web application, as a stand-alone software application, as an “app” application, and/or it may deployed as a software as a service product. As a possible commercial product, the software 106 may be provided with an accompanying end user licensing agreement, other user license requirements, and purchasable or licensable after payment of fees, such as a time-based subscription or user fee.

Turning next to FIG. 2, shown therein is schematic diagram of the clinical event management and communications system 100 of FIG. 1, showing several specific hardware 102 features of the invention. In particular, the clinical event management and communications system 100 may include one or more networks 202, which connect one or more servers 204 (only one shown), one or more computers 206 (only one shown), one or more portable devices 208 (only one shown), and one or more devices displaying a graphical user interface (GUI) 210 (only one shown) generated by the software 106.

The one or more networks 202 may be, for example, intranets or extranets at a hospital, and may include wired and wireless components.

The one or more servers 204 may include web servers, data servers, load balancers, communications servers, as well as related storage devices (not shown), such as database storage device. The one or more servers 204 and associated storage devices may store EHRs associated with

The one or more computers 206 may be, for example, a laptop or other computing device, such as those found within a hospital (or other healthcare facility) where nurses and doctors access various software application, and may include a display device 206a with a display 206c, internal storage device 206b, and input device (keyboard) 206d.

The one or more portable devices 208 may include, for example, a tablet computer, smartphone, persona data assistant, and the like.

It is to be understood that the above-described embodiment of the present invention, as well as the invention in all of its forms, may be embodied and implemented in hardware, software, firmware, special purpose computing devices, or a combination thereof.

With regard to the software 106, the present invention may be implemented as a program tangibly embodied on a program storage device. The software 106, as a program or program elements, may be uploaded to, and executed by, a machine comprising any suitable architecture, either centrally executed or executed on distributed devices networked to each other.

Preferably, the particular machine or machines executing the software 106 is/are implemented on a computer having hardware including one or more central processing units, one or more memory devices (such as a random access memory), and one or more input/output interface devices, such as peripheral device interfaces. The computer may also include an operating system and microinstruction code.

The various software-implemented processes and functions of the invention as described herein may either be part of the aforementioned microinstruction code or part of the software 106 program (or a combination thereof) which is executed via the operating system running on the computer.

In addition to the specific peripheral devices described above, the invention may encompass various other peripheral devices that are connected or networked to the computer. These include additional integral or external data storage devices, printing devices, and various sensors, including biological/physiological, environmental, and/or other sensors (and their associated hardware and software).

Also, because some of the constituent system components and associated or different methods for their use, as depicted in the accompanying figures, are preferably implemented in software, the actual connections between the components (or the method/process steps) may differ depending upon the manner in which the present invention is programmed.

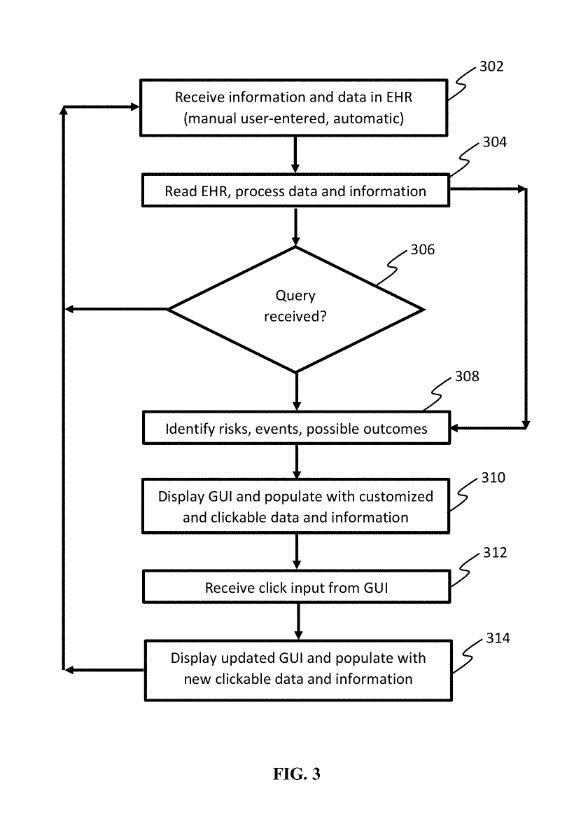

Turning now to FIG. 3, shown therein is a process flow diagram according to one aspect of the present invention.

In step 302, the EHRs records 104 are updated in real-time or near real-time with data and information inputted from various sources as shown in, for example, FIG. 1. The data and information may be received in the EHRs automatically or manually. Data and information received manually may be, for example, from a nurse entering a statement, such as “Patient X is feeling nauseous.” Data and information received automatically may be, for example, an MRI system that forwards electronic information to a patient's EHR.

In step 304, the software 106 reads all EHRs 104 according to rules 108 defining, among other things, the frequency and scope of reviews, and may index the information identified to facilitate identifying changes in the EHRs 104 from previous reviews.

The purpose of the reviews is to look for specific words, phrases, sentences, paragraphs, and other text, according to initial or pre-determined rules 108 developed in the course of “training” the software 106 following machine learning principles well known in the art. The aforementioned rules, variables, values, manifestations, etc. 108 may further be developed from, for example, a taxonomic or ontological list based on words regularly used by nurses, or found in or associated with vital signs, used in EHR and other records. The software 106 may look for specific words or phrases or combinations of words/phrases in particular portions of EHRs 104, a frequency of words/phrases in a particular location in a particular EHR 104, a proximity of words/phrases relative to the same or other words/phrases, etc. The software 106 “training” may be include decomposing existing knowledge base textual sources relevant to the healthcare field (e.g., science and medical dictionaries, treatises, etc.).

The result of the software 106 training (which is dynamic), is the ability of the software 106 to answer written or anticipated (predicted by the software) queries with the best possible answer or explanation, or several next best answers and explanations. Where necessary, the trained software 106 outputs are confined to, for example, acceptable ranges of values for specific variables, known and acceptable written manifestations for particular conditions or events, or other restrictions used to ensure the software 106 produces outputs that are bounded within acceptable norms. This might be useful, for example, to ensure incorrectly inputted values or misspelled or incorrect terms used in natural language inputs are handled appropriately, or to limit responses to queries prior to sufficient data available to the software 106 to perform statistical and other analyses.

The software 106 algorithms employed in the clinical event computations noted above may rely on sets of variables and associated values or descriptions of manifestations for each of several clinical event management categories. Those categories are described in more detail below, beginning with “fever,” which may be defined using number values and specific descriptive manifestations, and by the interventions shown in Table 1, which are also available to the software 106 as possible rules, variables, values, manifestations, etc. 108.

TABLE 1
Definition and Evidence of Fever

| Exemplary Definition | |
|---|---|
| of Fever | Exemplary Evidence or Manifestation |
| Elevation of body | Recorded temperature of >99 F.; recorded |
| temperature. | temperature greater than baseline |
| | Patient given medication(s) antipyretic(s) |
| | (Tylenol, for example) |
| | Patient states feeling warm (or similar) |
| | Peripheral circulation constricted, cool extremities |
| | Tachycardia, HR > 100 |
| | May have difficulty obtaining pulse |
| | oximetry due to cool extremities |
| | Patient given tepid cloth or bath |
| | Patient complaint of sweating or shivering |

“Pain” may be defined for use in the software 106 as provided in Table 2, and may be associated with a range from type (e.g., “tenderness”) to a pain score to more severe, changes in vital signs, and reduced comfort of the patient.

TABLE 2
Definition and Evidence of Pain

| Exemplary Definition | |
|---|---|
| of Pain | Exemplary Evidence or Manifestation |
| Complaint of or indication | Documented pain score of 1 or greater |
| of discomfort. | Administration of pain medication |
| | (Tylenol, Morphine, for example) |
| | Patient complaint of soreness or tenderness |
| | Assessment includes demonstration |
| | of patient withdraw reflex |
| | Patient moaning or crying out |
| | Restlessness |
| | Anxiety |
| | Tachycardia, HR > 100 |
| | Patient complaint of pain |
| | Increased respiratory rate |
| | Increased blood pressure from baseline |

The clinical event “bleeding” can be used by the software 106 in the form of a range based on observational evidence in dressings and drains to subtle bleeding that is nearly invisible, while internal bleeding, for example, may be observed as bruising increase in diameter of extremity or abdomen that are entered in the EHRs 104. Specific manifestations are shown in Table 3.

TABLE 3
Definition and Evidence of Bleeding

| Exemplary Definition | |
|---|---|
| of Bleeding | Exemplary Evidence or Manifestation |
| Any documented or | Frank to serosanguinous blood in stool, |
| assessment finding | emesis, urine, NG drainage |
| suggesting external or | Guaiac tested (+) for blood in stool |
| internal loss of blood. | Bloody or serosanguinous drainage in |
| | dressing or external drain |
| | Bruising that is new or worsening of older bruises |
| | Tachycardia, HR > 100 |

“Change in respiratory status” is a clinical event management category concerned with subtle changes in the patient's ability to breathe and exchange oxygen and carbon dioxide. The changes in condition can begin with problems that lead to changes in breathing to signs of difficulty breathing, as reflected in Table 4.

TABLE 4
Definition and Evidence of Change in Respiratory Status

| Exemplary Definition of | |
|---|---|
| Change in Respiratory | |
| Status | Exemplary Evidence or Manifestation |
| Any documented or | Pulse oximeter value drop to 90% or less |
| assessment finding | Increase in respiratory rate |
| suggesting change in | Decrease in respiratory rate |
| patient’s breathing. | Positive for shortness of breath or |
| | difficulty breathing |
| | Breath sounds include wheezing, “wet”, |
| | diminished, rales, rhonchi, crackles, stridor |
| | Change in symmetry of expansion and |
| | relaxation of chest during breathing |
| | Noted retractions or increased retractions |
| | with breathing |
| | Application of oxygen |
| | Increase in percent or flow of oxygen |
| | Increase or start of breathing treatments |
| | Patient complains of difficulty breathing |
| | Increase coughing, dry or productive |
| | Start of bronchodilator medication |
| | Restlessness |
| | Anxiety |
| | Tachycardia, HR > 100 |

“Change in level of consciousness” (LOC) is a clinical event management category that relies on an assessment of findings rather than hemodynamic changes, as reflected in Table 5.

TABLE 5
Definition and Evidence of Change in Level of Consciousness

| Exemplary Definition | |
|---|---|
| of Change in Level | |
| of Consciousness | Exemplary Evidence or Manifestation |
| Documented or | Increase in confusion |
| assessment finding that | Non-purposeful movement, restlessness |
| includes a change in | Decreased levels of alert and orientation x 4 |
| patient level of alertness. | (person, place, time, and situation) |
| | More difficult to wake from sleep |
| | Disorientation |
| | State of drowsiness and/or lethargy |

“Change in output” is a clinical event management category involving several body systems: renal, gastric, and cardiac. Change in output includes not only increase in output but also decrease in output. Change in output can also occur when a high or low output is expected but does not occur, as reflected in Table 6.

TABLE 6
Definition and Evidence of Change in Output

| Definition of Change | |
|---|---|
| in Output | Exemplary Evidence or Manifestation |
| Documented or | Patient has increase in urine output, >800-2000 |
| assessment finding that | ml/day of urine or 0.5-1 ml/kg/hr. |
| includes a change in | for average adult; 0.25-0.50 ml/kg/hr. |
| volume, increase or | adult >65 years of age |
| decrease of output. | Change in drainage for any drainage device |
| | already in place |
| | Presence of diarrhea, increase volume and |
| | frequency of stool |
| | Presence of emesis |
| | Constipation or decrease of stool |
| | Administration of diuretic |
| | Administration of diuretic and little output |
| | Low K+ |
| | Administration of K+ in IV (PO administration |
| | implies a chronic low K+) |
| | Administration of anti-diarrhea medication |
| | Administration of anti-emesis medication |
| | Administration of anti-diarrhea medication, and |
| | persistence of diarrhea |
| | Administration of anti-emesis medication, and |
| | persistence of emesis |
| | Tachycardia, HR > 100 |
| | Patient has decrease in urine output, <800-2000 |
| | ml/day of urine or 0.5-1 ml/kg/hr. |
| | for average adult; 0.25-0.50 ml/kg/hr. |
| | adult >65 years of age |
| | Gastric distention |
| | Insertion of draining device: JP, NG, Foley, |
| | straight catheter (any device draining fluid |
| | outside of body) |

As noted previously, the software 106 algorithms may also take into account multiple clinical event categories. It has been found that clinical events may present in two forms, a single clinical event (as listed above), or as multiple clinical events (or also in a cluster of clinical events). A single clinical event is one where the patient experiences any one of the clinical events identified above. Multiple or cluster clinical events may be evidence of an increase in severity and threat to the patient's safety. Evidence of a clinical event may also reflect another clinical event.

In the case of a single clinical event category, when evidence of one of the clinical events is apparent without evidence of a second clinical event, the software 106 may determine that a single clinical event category is appropriate for assessing potential events and managing the clinical event. For example, the patient will exhibit only fever, pain, bleeding, changes in respiratory status, level of consciousness, or output (Tables 1-6).

In the case of multiple or cluster clinical events, the evidence of more than one clinical event, for example, fever and pain, may be exhibited. For example, the patient may have a recorded fever and also states they are experiencing pain or has a recorded pain scale value. Additional examples of multiple clinical event categories that the present software 106 may assess are provided in Table 7, which is for illustrative purposes and is not an exhaustive list of manifestations of multiple or cluster clinical events.

TABLE 7
Exemplary Clinical Event Clusters

| Initial | Progressing | Continued Progression |
|---|---|---|
| Pain | Fever | |
| Pain | Fever | Changes in Respiratory |
| | | Status |
| Changes in | Changes in Level of | |
| Respiratory Status | Consciousness | |
| Changes in Output | Changes in Level of | |
| | Consciousness | |
| Bleeding | Changes in output | Changes in Level of |
| | | Consciousness |
| Bleeding | Pain | Changes in Level of |
| | | Consciousness |
| Pain | Fever | Changes in Level of |
| | | Consciousness |
| Pain | Fever | Changes in Output |
| Fever | Changes in Output | Changes in Level of |
| | | Consciousness |
| Pain | Changes in Level of | |
| | Consciousness | |
| Changes in Output | Pain | Changes in Level of |
| | | Consciousness |
| Bleeding | Changes in Respiratory | Changes in Level of |
| | Status | Consciousness |

The software 106 algorithms may also take into account overlapping clinical event categories in the cases where the clinical event categories may share common, similar, of indistinguishable manifestations, such as those highlighted with asterisks in Table 8, which is for illustrative purposes and is not an exhaustive list of overlapping values or manifestations.

TABLE 8
Exemplary Comparison of Clinical Events with Shared Manifestations

| | | | Change in | Change in | Change in |
|---|---|---|---|---|---|
| Fever | Pain | Bleeding | Resp Status | LOS | Output |
| Recorded | Documented | Frank blood | Pulse | Increase in | Patient has |
| temperature | pain score of | in stool, | oximeter | confusion | increase in urine |
| of >99 F.; | 1 or greater | emesis, urine, | value drop to | | output, >800-2000 |
| recorded | | NG drainage | 90% or less | | ml/day of urine |
| temperature | | | | | or 0.5-1 ml/kg/hr |
| greater than | | | | | for average adult; |
| baseline | | | | | 0.25-0.50 ml/kg/hr |
| | | | | | adult >65 years of age |
| Patient given | Administration | Guaiac tested + | Increase in | Non- | Presence of |
| antipyretic(s) | of pain | for blood in stool | respiratory | purposeful | change in NG |
| (Tylenol, for | medication | | rate | movement, | drainage for tube |
| example) | (Tylenol, | | | restlessness | already in place |
| | Morphine, | | | | |
| | for example) | | | | |
| Patient states | Patient | Bloody or | Decrease in | Decreased levels | New NG tube |
| feeling warm | complaint of | serosanguinous | respiratory | of alert and | inserted due to |
| (or similar) | tenderness | drainage in | rate | orientation x 4 | emesis or |
| | | dressing or | | (person, place, | increase gastric |
| | | external drain | | time, and | measure |
| | | | | situation) | |
| Peripheral | Assessment | Bruising that | Breath sounds | More difficult | Presence of diarrhea, |
| circulation | includes | is new or | include wheezing, | to wake from | increase volume and |
| constricted, | demonstration | worsening of | “wet”, diminished, | sleep | frequency of stool |
| cool | of patient | older bruises | Rales, rhonchi, | | |
| extremities | withdraw | | crackles, stridor | | |
| | reflex | | | | |
| ***Tachycardia, | ***Restlessness | ***Tachycardia, | Change in symmetry | Disorientation | Presence of |
| HR > 100, | | HR > 100 | of expansion and | | emesis |
| | | | relaxation of | | |
| | | | chest during | | |
| | | | breathing | | |
| May have | ***Anxiety | | Application | State of | Constipation or |
| difficulty | | | of oxygen | drowsiness | decrease of stool |
| obtaining | | | | and/or | |
| pulse | | | | lethargy | |
| oximetry due | | | | | |
| to cool | | | | | |
| extremities | | | | | |
| Patient given | ***Tachycardia, | | Increase in percent | | Administration |
| tepid cloth or | HR > 100 | | or flow of oxygen | | of diuretic |
| bath | | | | | |
| Patient | Patient | | Increase or start | | Administration |
| complaint of | complaint | | of breathing | | of diuretic and |
| sweating or | of pain | | treatments | | little output |
| shivering | | | | | |
| | Increased | | Patient complains | | Low K+ |
| | respiratory | | of difficulty | | |
| | rate | | breathing | | |
| | Increased | | Increase coughing, | | Administration |
| | blood pressure | | dry or productive | | of K+ in IV (PO |
| | from baseline | | | | administration |
| | | | | | implies a chronic |
| | | | | | low K+) |
| | | | Start of | | Administration |
| | | | bronchodilator | | of anti-diarrhea |
| | | | medication | | medication |
| | | | ***Restlessness | | Administration |
| | | | | | of anti-emesis |
| | | | | | medication |
| | | | ***Anxiety | | Administration |
| | | | | | of anti-diarrhea |
| | | | | | medication, and |
| | | | | | persistence of |
| | | | | | diarrhea |
| | | | ***Tachycardia, | | Administration |
| | | | HR > 100 | | of anti-emesis |
| | | | | | medication, and |
| | | | | | persistence of |
| | | | | | emesis |
| | | | | | ***Tachycardia, |
| | | | | | HR > 100 |

Turning back to FIG. 3, in step 306, the software 106 checks for entered queries. A query may be a natural language query such as, “What are Patient X's respiratory risks?”, “Has the patient had a fever since they were admitted?” and “How many patients have shown symptoms consistent with Valley Fever infection this year?” If no specific query is received within the specific period of time, the process loops back to the beginning and continues to receive data and information in the EHRs 104, except during this period the software 106 may automatically output data and information to a graphical user interface (such as those described below) based on predicted or expected queries, which may be, for example, a default query like “What is the patient's current risk for each clinical event category?” If a specific written query is received during the period of time noted above, the software 106 seeks to answer the query along with an explanation to support the answer. In doing so, the software 106 may identify risks, possible existing or future events, and possible patient outcomes, and changes thereto, as shown in step 308.

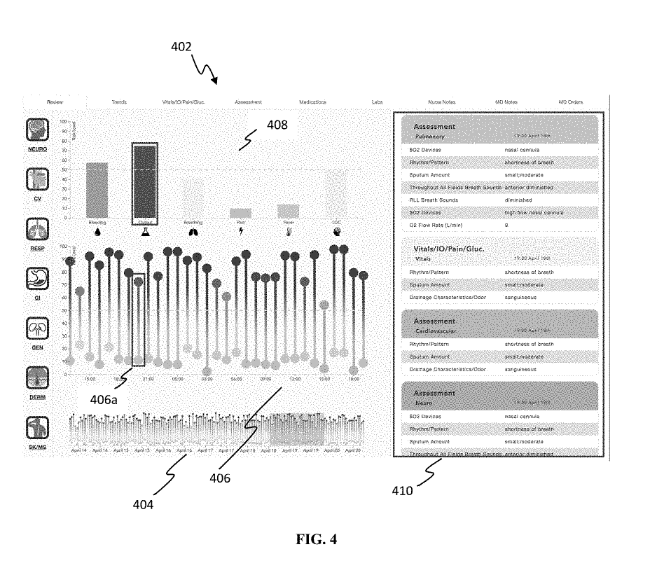

In step 310, the software 106 displays a summary graphical user interface, which includes customized and clickable data and information, as shown in, for example, FIGS. 4 through 7.

In step 312, the software 106 receives a click input from the graphical user interface displayed in step 310.

In step 314, the software 106 displays a new graphical user interface populated with additional clickable data and information. This is a “drilling down” process in which more detailed information is presented in case the user wishes to have more data and information than is presented in the summary graphical user interface of step 310.

Turning now to FIG. 4, shown therein is an exemplary graphic user interface 402 generated by the software 106 according to one aspect of the invention. The depicted graphical user interface, which may be considered the main or default view, includes three charts arranged in a specific order to enhance the interface's ability to effectively communicate information extracted from a patient's EHR and/or developed by the software 106. These include the time-series risk indicia overview chart 404, the time-series risk indicia focus chart 406, and the clinical event category-specific risk indicia chart 408, which are described in detail below. To the right of the three charts 404, 406, 408 is a scrollable text-based patient assessment chart 410, which collects and groups data from the patient's EHR. The graphical user interface 402 can augment the user interface provided by the EHR software developer, or replace it, where appropriate.

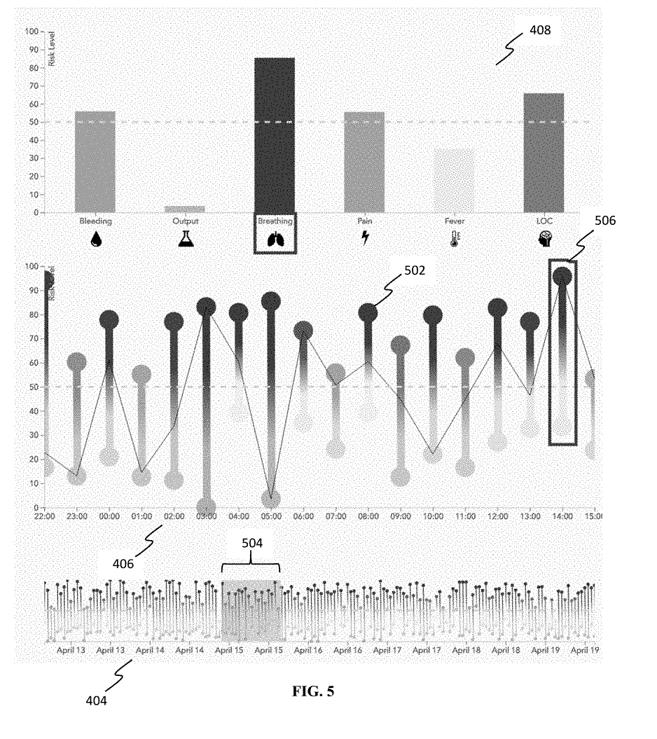

Turning now to FIG. 5, shown therein is another view of the three charts 404, 406, 408 of the graphical user interface 402, which are snap-shots made at a particular time (that is, the charts provide dynamic data and are regularly updated). The snap-short of the time-series risk indicia overview chart 404 of the graphical user interface 402 depicts the temporal-based risks of the main clinical events described above, based on a series of samples of patient assessments over a period of time (here, from 22:00 hours to 15:00 hours, consecutively). The time-series risk indicia overview chart 404 provides a user with a horizontally-scrollable (e.g., click-hold-slide) visual depiction of the overall time-based (in this case, hourly) fluctuations of a patient's health using the relative position of a particular type of indicia 502 (here, a dumbbell-shaped, color-coded bar, red at the top, green at the bottom, though other shapes and colors or patterns may be used).

The time-series risk indicia overview chart 404 also provides navigation capabilities by permitting a user to click or highlight a portion of the chart 504; and when clicked, a specific section of the chart data may be viewed. For example, the user may wish to view a few consecutive hours of risk fluctuations. Once the highlighted portion of the chart 504 is selected, the data will zoom in and focus only on those risk details, as described below.

The time-series risk indicia focus chart 406 displays the selected portion 504 in the time-series risk indicia overview chart 404. Each risk indicia 502 (e.g., dumbbell) can reflect a combined assessment of the six clinical event categories: fever, pain, bleeding, changes in respiratory status, changes in output, and level of consciousness. The combined risks are computed, as described herein, by the software 106 using the various system inputs and system information 108 as depicted in FIG. 1.: For example, once a nurse enters data in the EHR, the algorithm will search the quantitative and qualitative data and, based on the rules in the software, will detect risk of or presence of a clinical event. When a user wants to explore in more detail a particular time-specific risk assessment, like the 14:00-hour (2:00 PM) risk indicia (highlighted by a box, once it is selected), they can select the associated dumbbell indicia 506 for that hour by clicking on it. Once clicked, the data for that hour period of time will appear in the top of the graphical user interface 402, as described below.

The clinical event category-specific risk indicia chart 408 is displayed at the top of the screen because it provides the most comprehensive overview and details of risk of a patient that a nurse or other practitioner needs to see on a real-time basis. If a user clicks on one of the depicted clinical event management categories, such as “output,” then the panel on the right with the patient assessment chart 410 (as shown if FIG. 4) will display and provide the evidence within the patient's EHR that contributed to that specific risk graphically depicted in the chart 408. This level of information changes relative to the level of granularity, That is, if a user selects the middle chart, then all the data that contributed to each of the individual categories would be shown, but if a user selects an individual event, then only the evidence of that particular event would be shown.

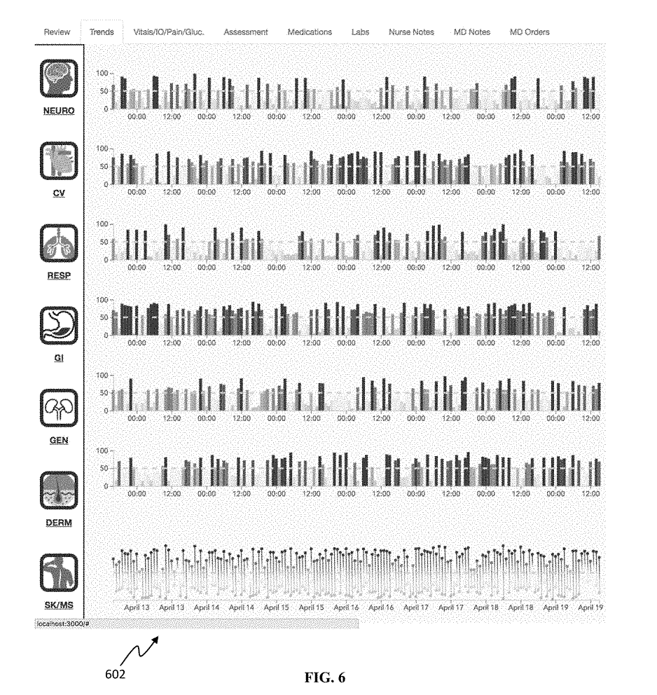

Turning now to FIG. 6, shown therein is another graphical user interface 602 according to one aspect of the invention, in which various temporal-based trends of risks of the main clinical events described above, other events, or specific physiological systems are presented in real-time (as often as the data are “reviewed” as described above and updated by the software 106). In the example shown, the x-axis is a time scale (here, 12-hour increments are used), and the y-axis is risk (0 to 100%). The indicia used to convey risk is in the form of color-coded bars (the higher the risk, the higher the bar, and red being used with a higher risk and green being used a lower risk, with other sizes and colors indicating a relative risk in between a high and a low risk). In this embodiment, each trend line is shown next to a labelled icon for “Neuro” (neurological), “CV” (cardiovascular), “Resp” (respiratory), “GI” (gastrointestinal), “GEN” (kidney), “Derm” (dermatological), and “SK/MS” (skeletal/muscular). Other trend lines, such as those for the main clinical events described above, may be selected for display instead of those shown.

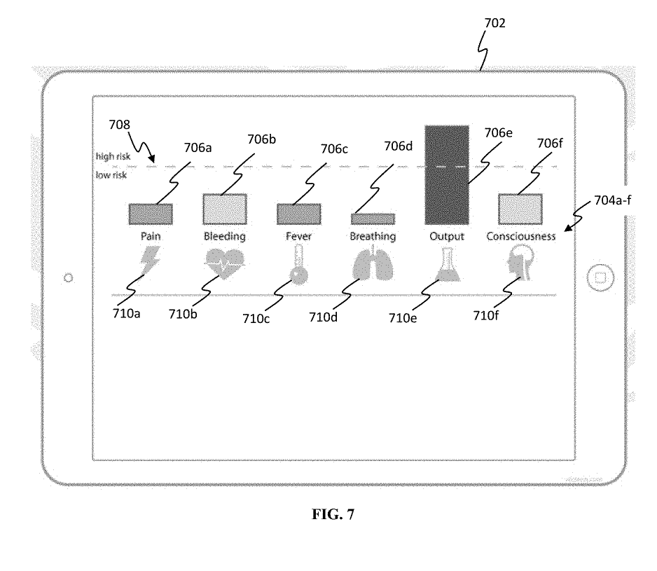

Turning now to FIG. 7, shown therein is another graphical user interface displaying a clinical event category-specific risk indicia chart 702, generated by the software 106 on the display of a portable device 208 (in this case, a portable, wireless, tablet computer display), which is an integral part of an “app” program running on the portable device 208. In the exemplary clinical event category-specific risk indicia chart 702 shown, specific portions of the display device of the portable device 208 are used to display specific information to enhance the effectiveness of information being communicated. In this case, the clinical event category-specific risk indicia chart 702 is divided into four rows of information (stacked on top of each other), and six columns of information (aligned side by side), forming a table or matrix containing individual display cells where information may be displayed.

In the top row of displayed information of the chart 702, a risk line 708 is displayed (in this case, a broken line), above which is considered a “high risk” condition or state, and below which is considered a “low risk” condition or state. Additional or different textual labels or icons could be used to indicate the relative risk associated with being above or below the risk line 708, and more than one risk line could be displayed between the rows of information. For example, “low,” “medium,” and “high” risk lines could be displayed instead of a single line, and those lines may be solid and a different color than that shown in the chart 702.

In the second row of information (below the top row) of the chart 702, six columns are provided across the width of the display thereby forming six cells for displaying information. As shown in FIG. 7, each cell is populated by an indicia, in this case different sized and colored graphic bars 706a through 706f, respectively. Each graphic bar 706a-706f may be used to represent a current physiological state or condition of the patient with regard to a specific health event, as calculated by the software 106. The bar's color (in this example, green, yellow, and red) and size (in this case, its height) may be used visually depict and represent the degree of the state or condition of the patient with regard to the particular health event. For example, a short green bar 706a might be used to represent an acceptable or low risk for a particular health event state or condition of the patient, while a taller, red-colored bar 706e might be used to represent an unacceptable or high risk for a different health event state or condition of the patient. The bottoms of each of the indicia graphic bars 706a though 706f may be aligned relative to a common risk baseline (e.g., zero or no perceived risk), while the tops of the bars are displayed relative to the risk line 708 to further provide a visual indication of the degree of risk.

As discussed previously, the software 106 may be provided with initial pre-determined criteria (e.g., a single default value, an average value, a range of values, etc.) (not shown) in which to compare actual clinical data and observations. The criteria are input into the system as described herein. Based on the comparison, the software 106 then selects an appropriate color and size for the graphic bars 706a through 706f. For example, the software 106 may use initial pre-determined body temperature criteria that are used to compare to actual patient body temperature values, input by, for example, a nurse, into the patient's EHR 104 at an emergency room. The comparison may indicate that the patient has a temperature condition that is 50% of a “high risk” condition. A green-colored bar with a height approximately one-half the distance to the “high risk” line on the chart 702 is caused to be displayed in the appropriate cell of the second row of information.

In the third row of the displayed chart 702, six columns are provided across the width of the display thereby forming six cells for displaying information. As shown in FIG. 7, each cell is populated by information labels 704a through 704f, respectively. Each label 704a through 704f may be used to describe a specific health event-related condition of the patient that is being monitored or for which health information is available (typically, events that are highly predictive of a negative outcome). In this case, the clinical events being monitored, and for which labels are depicted in the third row cells, are “Pain” (704a), “Bleeding” (704b), “Fever” (704c), “Breathing” (704d), “Output” (704e), and “Consciousness” (704f). The indicia graphic bars 706a through 706f are associated with each of those respective labels. More, fewer, or other clinical events and associated negative or adverse outcomes may instead be displayed using a different number of cells.

In the fourth (bottom) row of the chart 702, six columns are provided across the width of the display thereby forming six cells for displaying information corresponding to the six cells in the second and third rows described above. As shown in FIG. 7, each cell of the fourth row is populated by icons 710a through 710f, respectively. The icons 710a through 710f are pre-selected to be associated with the clinical event labels 704a through 704f, respectively, to further provide a visual indication of the clinical event. Thus, for example, a lightning bolt icon (710a) is used to represent “Pain,” while a lungs icon (710d) is used to represent “Breathing.” Other or different icons may be used.

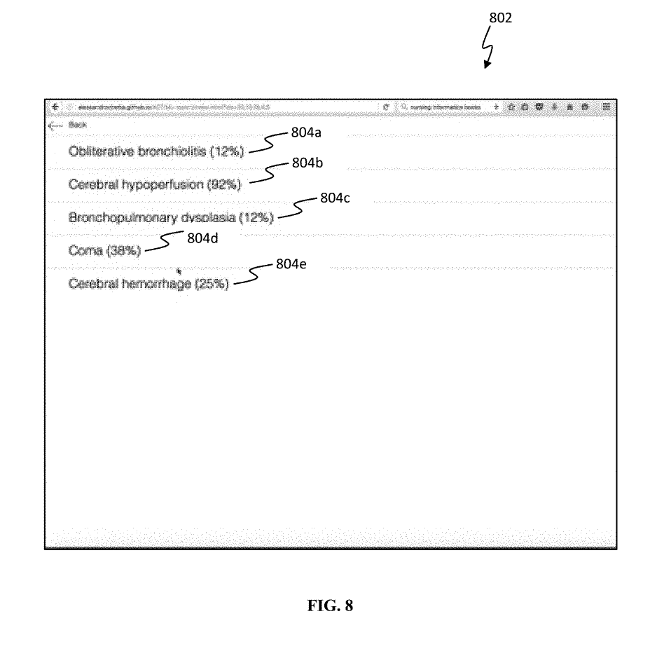

Turning to FIG. 8, shown therein is another exemplary graphical user interface 802, generated by the software 106 on the display of a computer 206, showing possible health conditions, diseases, and/or disorders and their associated risks (probability, expressed in percentage) based on existing physiological conditions of the patient as assessed by the software 106 using all of the data from the EHRs 104 and rules, values, etc. 108. The graphical user interface 802 shown is generated in a browser window; however, the graphical user interface 802 could instead be generated as part of an app (like the graphical user interface of FIG. 7, which is generated as part of an app). The displayed information in the graphical user interface 802 may be generated after a user clicks on a portion of the chart 702 of FIG. 7 or some other graphical user interface page available to the user. Thus, for example, the software 106 may operate an app on the computer 206 for displaying certain information, but also launch a browser program to display other information, and vice versa.

As shown in FIG. 8, the exemplary graphical user interface 802 shown provides a list of possible health conditions, diseases, and/or disorders for the patient: “Obliterative bronchiolitis (12%)” (804a), “Cerebral hypoperfusion (92%)” (804b), “Bronchopulmonary dysplasia (12%)” (804c), “Coma (38%)” (804d), and “Cerebral hemorrhage (25%)” (804e). Those possible clinical events and associated risk (both of which are clickable links) are selected and computed by the software 106, respectively, by at least using pre-determined criteria to which it compares actual clinical data and observations, which are input into the system as described herein. The software 106 further uses algorithms, as discussed herein, to compute the risk that the event has or will occur. In this case, the current conditions and state of the patient, as reflected in the EHR 104, are used by the software 106 to compute an estimated 92% chance that the patient is or will experience “cerebral hypoperfusion.”

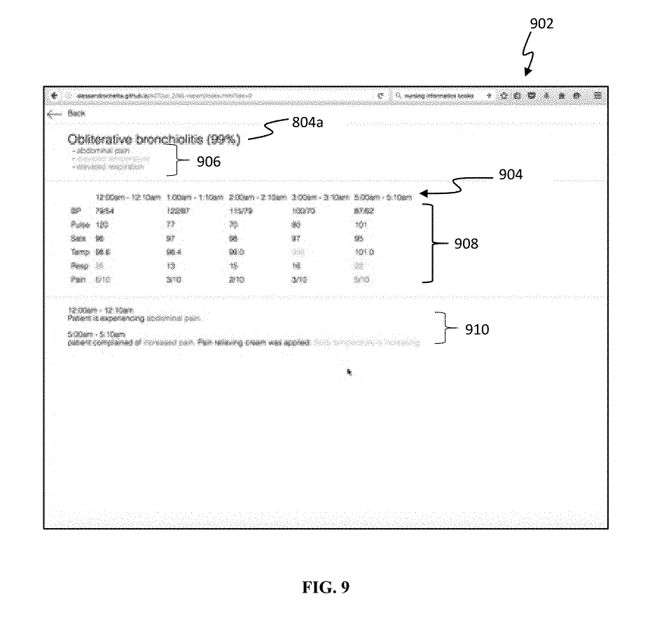

Turning now to FIG. 9, shown therein is another exemplary graphical user interface 902, generated by the software 106 on the display of the computer 206 (in this case, using a browser program, but could also be displayed as part of an app without a browser program). As shown, the graphical user interface 902 displays additional details explaining or supporting the results of the calculations displayed in the graphical user interface 802 of FIG. 8. The additional details may be generated and displayed after, for example, a user clicks on a portion of the graphical user interface 802 of FIG. 8 or clicking on some other graphical user interface page.

By way of example, if the user clicks on the “Obliterative bronchiolitis (12%)” (804a) link in FIG. 8, the information displayed in the graphical user interface 902 is displayed. At the top of the graphical user interface 902, the “Obliterative bronchiolitis (99%)” (804a) health event is now displayed as a title (with the risk value now being estimated by the software 106 as 99% likely to occur or actually occurring).

Below that health event title is a list 906 containing each of the conditions or the state of the patient identified by the software 106 as contributing to the 99% risk value, i.e. “abdominal pain,” “elevated temperature,” and “elevated respiration.”

To give the user additional insight into the data used by the software 106 in selecting the “Obliterative bronchiolitis” health event and the “99%” calculated the risk value, a table 908 is provided on the graphical user interface 902 with actual data inputted into the patient's EHR by nurses or automatically by connected sensors (i.e., sensors connected to the EHR). The rows of data are shown associated with different physiological parameters that are being monitored, along with a timeline 904 when the data were obtained. For example, during the 5:00-5:10 am time period, the patient had a respiration value of “22” and an abdominal pain value of “5/10,” both of which are indicated as being elevated (by the software 106 comparing the entered values to pre-determined criteria).

Below the table 908 on the graphical user interface 902 are displayed textual remarks 910, which may be entered by a nurse or other healthcare practitioner in the patient's EHR. For example, during the time period 12:00-12:10 am, the textual remark “Patient is experiencing abdominal pain” was entered, and is thus displayed. The software 106 evaluates textual remarks to identify the presence of health event-related terms (e.g., “abdominal pain”). A pre-determined list of such terms (and obvious variations of the terms) is provided to the software 106.

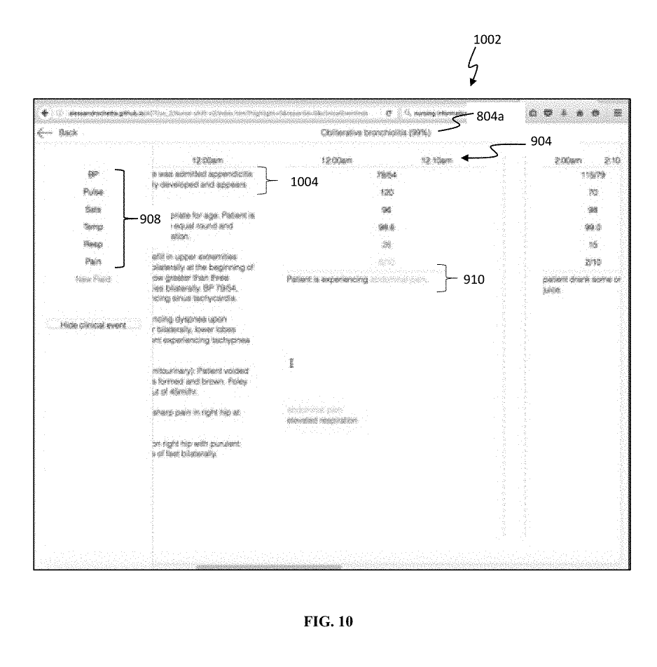

FIG. 10 shows yet another exemplary graphical user interface 1002, generated by the software 106 on the display of the computer 206 (in this case, using a browser program, but could also be displayed as part of an app without a browser program). As shown, the graphical user interface 1002 displays some of the same information as shown in FIG. 9, but can also display additional details explaining or supporting the information displayed in the graphical user interface 902 of FIG. 9, thereby providing a more complete and comprehensive view of the patient's conditions or state and possible health event(s). The additional details shown in the graphical user interface 1002 may be generated and displayed after, for example, a user clicks on a portion of the graphical user interface 902 of FIG. 9 or clicking on some other graphical user interface page.

In the graphical user interface 1002 example shown, detailed textual remarks 1004 are displayed below a particular time entry (here, 12:00 am). The textual remarks 1004 may be a compilation of previously entered remarks made by nurses during the most recent shift (thus, the complication of remarks 1004 may be those made by nursing staff after all or a portion of the most recent shift ending at 12:00 am).

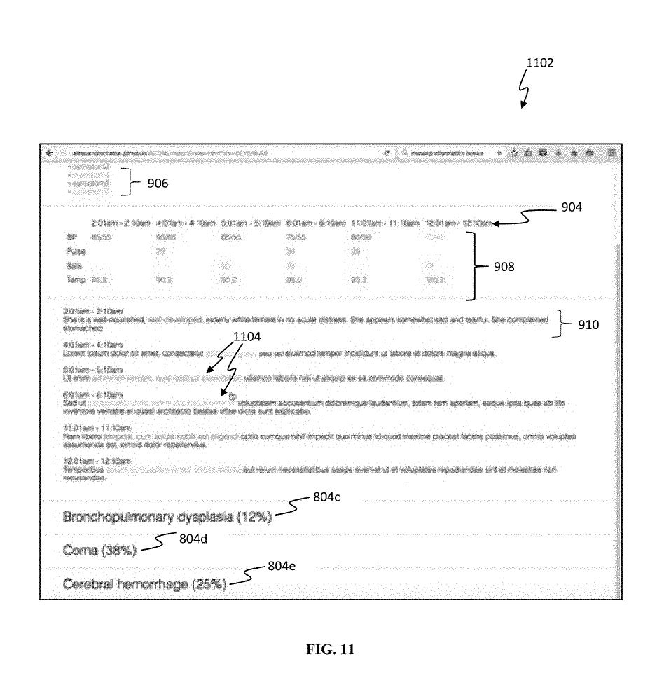

FIG. 11 shows yet another exemplary graphical user interface 1102, generated by the software 106 on the display of the computer 206 (in this case, using a browser program, but could also be displayed as part of an app without a browser program). As shown, the graphical user interface 1102 displays some of the same information as shown in FIGS. 8, 9 and 10, but can also display additional details explaining or supporting the information displayed in the graphical user interfaces 802, 902, and 1002, thereby providing a more complete and comprehensive view of the patient's conditions or state and possible health event(s). The additional details shown in the graphical user interface 1002 may be generated and displayed after, for example, a user clicks on one of the other possible health events for the patient (i.e., other than the “Obliterative bronchiolitis” health event link in FIG. 8. Thus, for example, if the nurse or other healthcare practitioner wanted to see the information used by the software 106 to identify as a possible health event “Cerebral hypoperfusion,” the user could click (or tap) on the link “Obliterative bronchiolitis (92%)” (504b) shown in the graphical user interface 802.

Once clicked, the software 106 causes the browser to display, for example, the list 906 containing each of the conditions or the state of the patient identified by the software 106 as contributing to the 92% risk value for “Cerebral hypoperfusion.” Here, the list 906 identifies (generically) “symptom 3,” “symptom 4,” etc., for illustrative purposes.

The software 106 also causes the browser to display, for example, the table 908 with actual data inputted into the patient's EHR by nurses or automatically by connected sensors (i.e., sensors connected to the EHR). The rows of data are shown associated with different physiological parameters that are being monitored, along with a timeline 904 when the data were obtained. For example, during the 2:01-2:10 am time period, the patient exhibited below normal (or expected) blood pressure (“BP”) and temperature (“Temp”) values (as determined by the software 106 by comparing the entered values to pre-determined criteria for the “Cerebral hypoperfusion” health event).

The graphical user interface 1002 is also used to display the textual remarks 910 entered by a nurse or other healthcare practitioner in the patient's EHR. The software 106 evaluates textual remarks to identify the presence of health event-related terms 1104. A pre-determined list of such terms (and obvious variations of the terms) is provided to the software 106 for the “Cerebral hypoperfusion” health event.

By way of a further brief example of the use of the present invention, and with reference to the event “change in output” event shown in FIG. 7 and the process of FIG. 3, the software 106 identifies from a patient's EHR an output volume of 900 ml, which falls within the “normal” range by rule (i.e., not less than 800 ml, not more than 2000 ml; not indicated as “frequent urination,” and not indicated as “difficulty voiding”). The software 106 also identifies that the patient has been administered a dosage of Enduron PRN by searching for and identifying the text “patient is on Enduron PRN for hypertension” that was entered in the EHR. The software 106 further identifies that Enduron is a diuretic and that diuretics cause frequent urination, both of which are obtained from a knowledge base or database. The software 106 then identifies statistical data reflecting average, median, and various ranges of outputs of similarly-situated patients who have been administered Enduron. The software 106 then identifies that the 900 ml “normal” patient output volume is in fact “abnormal” and should be higher than 900 ml, and it may estimate that the patient's output should be more than 2000 ml. The software 106 then identified the “change in output” parameter associated with the patient as a CE. The software 106 then updates the summary graphical user interface 702 of FIG. 7 by increasing the height of the “change in output” indicia 706 (red bar) so that it reflects a high risk. The software 106 further outputs an alert in textual or audible form.

A nurse or other user may then click on the red “output” bar 704, which causes additional details to be displayed on the same or a different graphical user interface page. That page may itself have links to even greater detailed information, all of which is helpful to the nurse/user understand why the software 106 indicates the patients' “output” places the patient in a “high risk” clinical event condition.

As noted above, the software 106 identifies statistical data reflecting average, median, and range values for various monitored physiological parameters on a per-patient or patient population basis, including values for typical symptoms monitored by nursing staff (e.g., temperature, blood pressure, etc.). The software 106 is initially provided with default values, but as more patient data is received, the system updates the statistical average, median, and range values so that it can identify what is “normal” or “abnormal” patient physiology, make appropriate decisions about the likely event that is or will be occurring, and provide more accurate responses to user-entered natural language queries.

Those skilled in the relevant art will appreciate that terms and phrases used herein to describe aspects, advantages, objects, and features of the invention are not to be construed as necessarily definitional or implying a specific definition. In general, the terms and phrases used to describe and claim the present invention should not be construed to limit the invention to any particular disclosed embodiment. Instead, the invention encompasses specific described embodiments, as well as equivalent aspects, advantages, objects, features, and ways of practicing or implementing the present invention.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

1. A system comprising:
at least one electronic health record stored in a database or memory of a computer device, the at least one record being associated with a patient undergoing treatment by a health care provider, and wherein the at least one record comprises information of or about the past or present health of the patient;
a software embodied on a computer readable media device, wherein the software is adapted to identifying a risk of occurrence of each one of a plurality of pre-determined clinical events based at least on the information and for outputting a response to a user query input;
a first graphical user interface portion of a display for displaying a plurality of graphics, each one of the graphics being associated with one of the plurality of pre-determined clinical events and each one of the graphics indicative of a degree of the risk of occurrence of the clinical event; and
a second graphical user interface portion of the display for displaying textual or graphical information used by the software subsystem in identifying the risk of occurrence and for displaying the outputted query response.

2. The system according to claim 1, wherein the pre-determined clinical event types are one or more of a pain event, a bleeding event, a fever event, a respiratory event, an output event, and a level of consciousness event.

3. The system according to claim 2, wherein the pain event is identified based on at least a complaint of or indication of discomfort of the patient,
wherein the bleeding event is identified based on at least the patient's external or internal loss of blood,
wherein the fever event is identified based on at least an elevation of the patient's body temperature,
wherein the respiratory event is based on at least a change in the patient's breathing, wherein the level of consciousness event is based on at least a change in the patient's level of alertness, and wherein the output event is based on at least a change in volume of the patient's urinary output.

4. The system according to claim 1, wherein the software-identified risk of occurrence is further based on either or both of a plurality of sets of rules, each one of the sets of rules being associated with one of the plurality of pre-determined clinical events, and a plurality of sets of manifestations descriptions, each one of the sets of manifestations descriptions being associated with one of the plurality of pre-determined clinical events.

5. The system according to claim 4, wherein the software-identified risk of occurrence is identified at least by comparing evidence of a patient's condition with one or more of the rules and manifestations descriptions.

6. The system according to claim 5, wherein the comparison is useful in identifying whether to output an alarm.

7. The system according to claim 1, wherein the software-identified risk of occurrence is an initial risk, a past risk, or a present risk of occurrence.

8. The system of claim 1, wherein the display is a component of a portable computing device.

9. A method comprising:
receiving at least one electronic health record in a database or memory of a computer device, the at least one record being associated with a patient undergoing treatment by a health care provider, and wherein the at least one record comprises information of or about the past or present health of the patient;
identifying, by a software embodied on a computer readable media device, a risk of occurrence of each one of a plurality of pre-determined clinical events based at least on the information;
displaying in a first graphical user interface portion of a display, a plurality of graphics, each one of the graphics being associated with one of the plurality of pre-determined clinical events and each one of the graphics indicative of a degree of the risk of occurrence of the clinical event; and
displaying in a second graphical user interface portion of the display, a textual or graphical information used by the software subsystem in identifying the risk of occurrence.

10. The method according to claim 9, further comprising: receiving a query of or about the health of the patient; and
outputting by the software a response to the query based on at least the information in the electronic health record and the identified risk of occurrence.

11. A graphical user interface adapted for communicating information to a health-care provider during treatment of a patient comprising:
a first chart portion of the graphical user interface for di splaying a chart of a plurality of first indicia indicative of the present and past state of the patient's risk of experiencing one or more of a plurality of pre-determined clinical events, where each of the plurality of first indicia is associated with a specific time period and wherein a subset of the displayed plurality of first indicia are selectable by a user using an input device;
a second chart portion of the graphical user interface positioned relative to the first chart portion for displaying a chart of a selected subset of the displayed plurality of first indicia, wherein each one of the displayed plurality of first indicia of the selected subset displayed in the second chart is further selectable by a user using an input device; and
a third chart portion of the graphical user interface positioned relative to the second chart portion for displaying a plurality of second indicia, wherein each of the displayed plurality of second indicia is associated with one of the plurality of pre-determined clinical events, and wherein each of the di splayed plurality of second indicia is indicative of the present state of the patient's risk of experiencing the respective pre-determined clinical event, and wherein each of the displayed second indicia is selectable by a user using an input device.

12. The graphical user interface according to claim 11, further comprising a fourth chart portion of the graphical user interface for displaying information and data used to calculate and to indicate by way of the displayed second indicia the present state of the patient's risk.

13. The graphical user interface according to claim 11, wherein the indicated past and present risk is calculated by a software subsystem embodied on a computer readable memory device, wherein the software subsystem is adapted to calculating the risk based on one or more of a plurality of rules and based on information in one or more electronic health records associated with the patient.

14. The graphical user interface according to claim 11, wherein the graphical user interface is adapted to being displayed on a display component of a computer device used by the health-care provider.

15. The graphical user interface according to claim 11, wherein the each of the first indicia comprises a rectangular-shaped graphic having a length dimension proportional to the risk calculated for each one of the plurality of pre-determined clinical events at a specific time period, or having a length dimension proportional to the aggregated risk calculated for all of the plurality of pre-determined clinical events.

16. The graphical user interface according to claim 11, each of the first indicia comprises a color selected from one or more of red, yellow, and green, wherein the color is selected based on the degree of risk calculated for each one of the plurality of pre-determined clinical events at a specific time period, or is selected based on the degree of aggregated risk calculated for all of the plurality of pre-determined clinical events.

17. The graphical user interface according to claim 11, wherein the pre-determined events are conditions of the patient classifiable as either a pain event, a bleeding event, a fever event, a respiratory event, an output event, and a level of consciousness event.

18. The graphical user interface according to claim 11, wherein the graphical user interface is generated by a software application embodied on a computer readable media.

19. A system for communicating information to a health-care provider during treatment of a plurality of patients comprising:
a plurality of electronic health records accessible to the health-care provider, each one of the plurality of electronic health records being associated with respective ones of the plurality of patients; and
a software adapted to generating the graphical user interface according to claim 11.

20. The system according to claim 19, wherein the software is downloadable from a server.
